(19) United States
(12) Patent Application Publication
(10) Pub. No.: US 2022/0053970 A1
(43) Pub. Date: Feb. 24, 2022

(54) MACHINE AND PROCEDURE FOR PREPARING HOT DRINKS

(71) Applicant: CREM INTERNATIONAL SPAIN, SL., Gandia (ES)

(72) Inventors: Juan Antonio CANET PEIRO, Gandia (ES); Jose Maria BORDES COSTA, Pego (ES)

(73) Assignee: CREM INTERNATIONAL SPAIN, SL., Madrid (ES)

(21) Appl. No.: 17/275,397

(22) PCT Filed: Oct. 2, 2019
(86) PCT No.: PCT/ES2019/070663

§ 371 Date: Mar. 11, 2021

(30) Foreign Application Priority Data
Oct. 22, 2018 (ES) P201831024

(51) Int. Cl. A47J 31/52; A47J 31/56; A47J 31/46

(52) U.S. Cl. CPC A47J 31/5253; A47J 31/5255; A47J 31/468; A47J 31/56; A47J 31/461; A47J 31/5251

(57) ABSTRACT

Procedure and machine for preparing hot drinks starting from a tank of water at atmospheric pressure that allows fine adjustment of the infusion and extraction parameters, as well as automatic or manual management thereof, by way of at least one control unit, with selection being allowed by way of a rotary coder with a button function, the machine being equipped with a single rotary pump controlled by way of a pulse-width modulation circuit and with wireless communication means. The machine is destined for the industrial sector of manufacturing machines for preparing hot drinks.

### BACKGROUND

### 1. Field of the Disclosure

The present disclosure lies within the field devoted to the manufacture of machines for preparing hot drinks.

### 2. Discussion of the Background Art

Many disclosures and procedures exist in the prior art which adapt or improve the producing of hot drinks, many of them being known, such as those devoted to preparing various beverages in a single machine, as is the case in particular with automatic dispensing machines, which therefore need to adjust the pressure and temperature, for example, depending on whether preparing an instant freeze-dried beverage or tea; the most recent innovations incorporate a logic implentation and a storage medium under a control unit; the incorporation of a microprocessor is already seen in machines such as those of the applicant Illycaffé S.P.A. with priority date of 4 May 1982, published in Spain as No. 8403175, which already envisions the possibility of a control of the extraction parameters by taking data from a plurality of sensors, as well as the storage of these data. Another example of this type can be found in the patent WO 2011/143483 of the applicant Crane Merchandising Systems, Inc, which comprises a coffee maker machine with a movable press and a controller that adjusts a grinder to different grain sizes and has a user interface for selecting the type of beverage; it does not dwell on how to produce an adequate adjustment of the pressure, or how the elements of the machine contribute to producing a technical effect that improves the known art of making hot drinks. Other documents, such as the European patent with publication number 2502478 of the applicant Rheavendors Services S.P.A., describe a procedure for the preparation of beverages involving the adjustment and management of the extraction parameters by means of a control logic implemented in a control unit for the making of the beverages, the flow rate being adjusted thanks to the contribution of two or more pumps which are connected in series, and also the volume of the preparation chamber is adjusted by means of two pistons that are controlled independently. This technical solution proves to be complex in its implementation, for cost reasons, and it differs clearly from the one proposed here.

Other solutions for achieving an adequate selection of the preparation parameters, specifically the regulation of the flow rate, are accomplished by the use of a regulable, proportional solenoid valve, controlled from a control unit, the contribution of this element being found in the patent EP 2314183 of the applicant Gruppo Cimbali S.P.A. The patent also describes the distribution of other components such as filters, or the location of the transducers.

For the rest, no other procedures or machines like the one described in the proposed disclosure are known.

To equip machines for preparing hot drinks with a procedure and machine enabling an improvement over the presently known prior art relative to the control of the infusion and extraction processes of the drink, allowing fine adjustments in the parameters of pressure, temperature, and time; at the same time allowing a control unit to process these data, to store them and to retrieve them at will, improving the capabilities of these machines and the user experience; the resulting machine is able to produce these results by introducing technical changes that are feasible for practical implementation on account of their practicality and low cost, providing technical improvements that affect the preparation of beverages and the robustness and reliability of the machine.

### SUMMARY

The present disclosure offers technical solutions that improve the preparing of hot drinks as compared to the currently existing machines, such that the proposed machine and its procedure involve a management of the parameters that regulate the infusion and extraction of the raw materials of plant origin to obtain the corresponding hot drinks. The machine for the making of hot drinks comprises a tank for water, which is open and therefore at atmospheric pressure, thereby facilitating the working of the pump, since its conditions are constant and known; this tank receives the water from the mains and has means of ensuring adequate storage levels of the water by means of a capacitive level sensor and software alarms situated in at least one control unit to ensure that the tank never drops below a minimum pre-established level which might allow an entry of air into the pump; if necessary, this may be filled manually. There is a flow meter situated between the tank and the boiler, and a single DC rotary pump, the speed of which is regulated by means of a pulse width modulation circuit; downstream from the pump, there is a check valve and a boiler with heating element that routes the water to the dispensing assembly, where the extraction of the beverage takes place. This assembly can be operated by means of a mechanical or an electromechanical actuator, the opening of which takes the prepared beverage to its container. The control unit comprises, on the one hand, means for making the adjustments required by the user by the use of an incremental rotary encoder with push-button function and a graphic interface to represent both the options and the results, provided with a selection keypad; on the other hand, the control unit collects and interprets, by means of a control logic, the signals provided by the systems for control of the level of the tank, the flow meter, the pressure transducer, and the temperature transducer of the boiler; it has at least one memory and a clock for setting a time base of the events, as well as means of communication, preferably being wireless, such as WiFi or Bluetooth.

The procedure for the preparing of hot drinks carried out by the proposed machine comprises means for entering the user's preferences by using a rotary encoder with push-button function, the actuating of which in both the clockwise and counterclockwise direction allows the selecting of a mode that shall be called the recipe, and using the push-button to access a second personalized adjustment mode, the options so selected being displayed on a graphics interface that supplements and broadens the selection of the described encoder using a conventional keypad; when the recipe mode is selected, we can choose among the different standardized options, thanks to having a control unit with at least one memory for these data and means for the interpretation of the characteristic parameters collected by the transducers of flow rate and pressure, situated upstream from the boiler and heating unit, and therefore working at a temperature close to the input temperature, which extends the lifetime of these components; as well as the corresponding temperature transducer located in the boiler, which will be used to produce the selected recipe. The push-button is used to select the beverage and prepare it, and the at least one control unit with a PID logic and a pulse width modulation circuit is used to command a single DC rotary vane pump, which provides the water coming from a tank containing the water at atmospheric pressure with the pressure and flow rate adjustments saved in memory to a boiler with heating element, and from here to the dispensing assembly, and from this to the glass or cup. In an additional aspect, the procedure allows the entering of recipes through at least one communication port.

It is to be noted that, when the water of the tank is at atmospheric pressure, the conditions of the pump will always be identical and known, unlike when operating directly from the water main, which might make its operation more complicated, since the pressure will vary according to the location of the machine and may even be determined by the condition of the water at a particular moment.

In a second mode contemplated in the procedure, the selection of the user by way of the encoder and its validation by means of the actuating of its push-button enables the selecting of a personalized adjustment mode, which allows an adjustment to be carried out, while the beverage is being prepared, of the pressure and/or flow rate parameters as provided by the pump and the time of infusion and extraction; after the beverage has been prepared, it is possible to save these parameters for the making of future beverages. The procedure envisions that the future dispensing will correspond to the one saved in memory, generating a visual and/or acoustic alarm when the dispensing flow rate is outside a pre-established range (between a minimum and a maximum), ensuring the proper dispensing of the beverage and indicating potential problems in the hydraulic system (possible blockage) or differences in the preparation of the raw materials of the beverage making it impossible to repeat the dispensing with the previously memorized parameters, for example, in the case when the ingredient for the preparation of a beverage may have a different degree of moisture content or compactness.

### BRIEF DESCRIPTION OF THE DRAWINGS

FIG. 1 illustrates schematically the procedure for preparing hot drinks when the user has opted for the recipe mode.

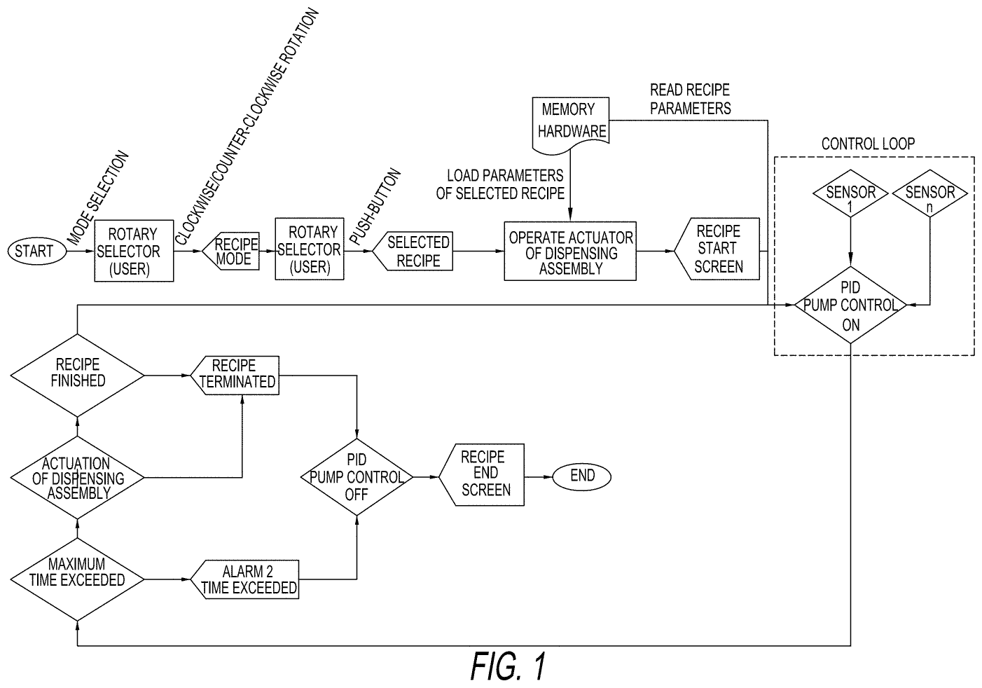

FIG. 2 illustrates the procedure when the personalized adjustment mode is selected.

FIG. 3 shows a block diagram of the machine for preparing hot drinks that is the subject of the present disclosure, showing: the element 12 represents the tap water supply valve; 1 represents the open water tank; 2 is the DC rotary vane pump; 3 is the pressure transducer; 4 is the check valve; 5 is the flow rate transducer; 6 is the boiler with heating element; 13 is the capacitive sensor of the tank level; 7 is the dispensing assembly, and 8 is its actuator (which may be mechanical or electromechanical), allowing the water to proceed into the beverage ingredients. The element 15 represents the control unit of the machine for preparing hot drinks; 10 is the incremental rotary encoder; 14 is the means of communication; 9 is the display interface with the input buttons 11.

### DETAILED DESCRIPTION OF A PREFERRED EMBODIMENT

A preferred embodiment shall be given as an example, but the disclosure is not limited to this:

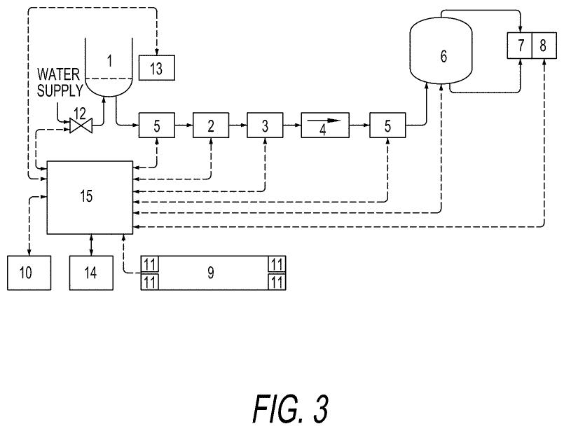

The machine according to this procedure can be seen in FIG. 3; it comprises a tank 1 for containing the water, being open and therefore at atmospheric pressure, which as described previously allows it to maintain a constant and known input pressure; its filling from the mains is conducted by way of the supply valve 12, and it may also be filled by hand, since it is open; it comprises means for ensuring an adequate water level for its functioning, said means composed of a capacitive water level sensor 13. It comprises a single DC rotary pump 2 whose speed is regulated by means of a pulse width modulation circuit; downstream from this there is installed a check valve 4, a boiler with a heating element 6 and a temperature sensor, from which the water for the beverage is routed to the dispensing assembly 7, where the extraction of the beverage is produced; in this preferred embodiment, the assembly is operated by means of an electromechanical actuator 8, the opening of which carries the already prepared beverage to its container.

In order to detect the parameters needed for the preparing of the beverages, the machine comprises the following transducers: at least one transducer for flow rate and one transducer for pressure, situated upstream from the boiler and heating unit, therefore working at the water inlet temperature, which extends the service life of these components. In order to interpret the signals of the transducers, as well as to adjust the parameters of the machine as a function of the beverage being prepared, the machine comprises at least one control unit 15 with a control logic, at least one memory for storing the data, and a clock to establish a time base for the events and means of communication 14, preferably wireless, such as WiFi or Bluetooth. In order for the user to opt for the recipe or the personalized adjustment mode, as described in the preceding, the machine comprises an incremental rotary encoder with push-button function 10 and a graphics display interface 9 having a keypad 11. It comprises means of alerting the user to situations involving the safety and proper working of the equipment by means of a visual and/or acoustic alarm when: the tank has a water level below the minimum established for an indicated period of time, or when a manual filling is needed, due to lack of filling from the mains; a visual alarm and blocking to prevent a possible overflow, restricting the maximum volume that can be dispensed in a single beverage. These means are embodied in at least one control unit that collects the signals of the transducers and the control algorithm that is performed therein, being displayed as mentioned through the graphics display interface of the machine.

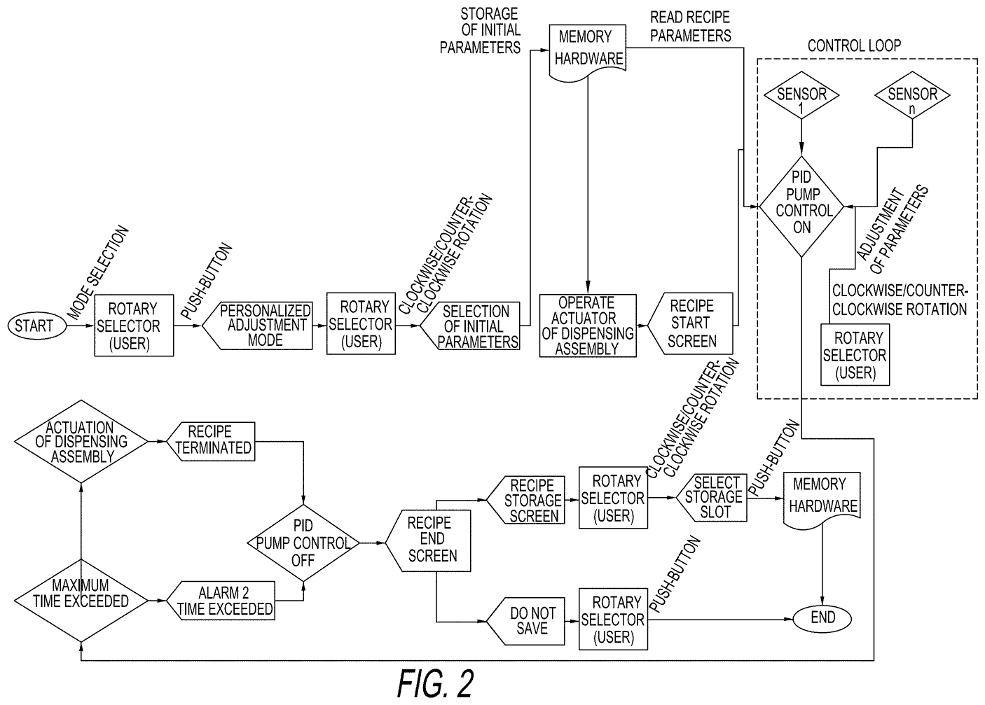

With reference to FIG. 2, the procedure begins by selecting a mode for producing beverages. choosing between a mode known as the recipe mode and a second mode of personalized adjustment; this initial selection is made by acting on a rotary encoder with push-button function, which will be used to validate the desired option, which in this case shall be called the personalized adjustment mode; the selected mode is shown on the graphics interface; again, by means of the rotary encoder, it is possible to pre-select the initial parameters for the pre-infusion phase of the beverage, in particular giving them values as a function of the preferences of the user of the machine; after these are validated by means of the push-button of the encoder, the machine will not start the preparation of the beverage until the actuator of the dispensing assembly is operated by the user. Once this is done, the user is able to change the parameters of extraction pressure and/or flow rate during the process of preparation of the beverage by means of the rotation function of the encoder, and these parameters will be displayed on the graphics interface.

Thanks to its control unit and the sensors of the machine as described, the pump is controlled and/or adjusted by a pulse width modulation to ensure that the values that are read conform to those previously entered by the user. The procedure envisions a stopping of the pump when the dispensing assembly is acted upon or when the maximum time of preparation is exceeded, the latter circumstance protecting the machine from possible accidents and/or damage due to overflowing. Finally, the graphics interface will indicate the end of the recipe, providing the option of storing in the memory of the machine the parameters used in the preparation of the beverage, by means of the rotary encoder, and by subsequent validation by means of the push-button, it being possible to select their storage slot in the event of opting for this option, in order to reproduce these adjustments in later beverages by means of the recipe mode, and the cycle will be finished.

1. A machine for preparing hot drinks for which it is possible to measure and to adjust parameters of pressure, time, and temperature that are needed in the phases of infusion and extraction, wherein said machine has a single DC motorized rotary pump regulated by a pulse width modulation circuit for which the water supply at atmospheric pressure is provided from a tank, the upper portion of which is open, and which has means of ensuring its water level by means of a capacitive water level sensor and by the supplemental operation of an electric valve connected to the supply mains; and in that it has at least one flow meter situated between the tank and the boiler with heating element, a pressure transducer downstream from the pump, a check valve and a dispensing assembly with an actuator, in that it has a control unit to enter the type of beverage being prepared, and for allowing a variation of the parameters for preparing the beverage and recording these for future use in at least one memory, these means of selection being embodied by a rotary encoder with push-button function and a graphics display interface having a conventional keypad; the machine comprises means of communication such as a USB port and/or wireless means such as WiFi or Bluetooth.

2. The machine for preparing hot drinks according to claim 1, wherein the control unit is configured to allow two modes of use, a first mode of personalized adjustment that enables a regulating, at the will of the user, of the parameters of infusion and/or extraction of the raw materials of plant origin during the process of making hot drinks, and a second recipe mode allowing the future dispensing to correspond to that of the personalized adjustment, comprising:
at least one memory for storing and subsequently using these parameters;
a rotary encoder with push-button function;
a data display interface with a keypad;
a single DC motorized rotary pump whose speed is regulated by means of a pulse width modulation circuit;
a flow rate transducer and a pressure transducer situated upstream from the boiler;
a capacitive sensor of the water level of the tank;
means of visual and/or acoustic alarm used to indicate when the dispensing time is exceeded or, in the recipe mode, when the dispensing flow rate is outside a pre-established range between a minimum and a maximum.
